(19) United States
(12) Patent Application Publication
(10) Pub. No.: US 2014/0324630 A1
(43) Pub. Date: Oct. 30, 2014

(54) SYSTEM AND METHOD FOR DELIVERING RELEVANT, LOCATION-SPECIFIC GIS INFORMATION TO A MOBILE DEVICE

(71) Applicant: WolfGIS, LLC, Pell City, AL (US)

(72) Inventors: John Michael Golden, Pell City, AL (US); U. Angus MacGreigor, Park City, UT (US)

(73) Assignee: WolfGIS, LLC, Pell City, AL (US)

(21) Appl. No.: 14/265,352

(22) Filed: Apr. 29, 2014

Related U.S. Application Data
(60) Provisional application No. 61/817,225, filed on Apr. 29, 2013.

(51) Int. Cl. G06Q 30/06; H04W 4/02

(52) U.S. Cl. CPC G06Q 30/0623; H04W 4/02
USPC 705/26.61; 455/456.3

(57) ABSTRACT

The current invention provides systems and methods for requesting all relevant shapefiles or satellite imagery data for a parcel of land from a mobile GIS App and e-commerce web portal. The parcel of land can be designated for request by address, parcel identification, latitude and longitude coordinates, or geolocation data determined by a GPS chip set or other means resident on a handheld mobile device. The system includes a cloud computing environment for processing and storing all requested shapefiles and work flow process shapefiles. The system processing of relevant shapefiles includes rendering the shapefile for portability to multiple smart technology mobile device operating systems. In another aspect, systems and methods are described for creating and delivering concatenated shapefiles from two or more shapefiles to a mobile GIS App and e-commerce web portal. In yet another aspect, systems and methods are described for detecting and alerting a mobile GIS user of an area of contention in a shapefile due to GIS data conflicts between two or more shapefiles. In still a further aspect, systems and methods are described for stitching and delivering 3D satellite imagery to a mobile GIS App and e-commerce web portal.

### CROSS-REFERENCES TO RELATED APPLICATIONS

This application claims the benefit of U.S. Provisional Application No. 61/817,225, filed Apr. 29, 2013, which is incorporated herein by reference in its entirety.

### FIELD OF THE INVENTION

The present invention relates generally to GIS services on a handheld device. In greater particularity, the present invention relates to a system for an on demand GIS service for supplying a user with relevant GIS data for a parcel of land or longitude/latitude coordinate of interest using a handheld (mobile) device.

### BACKGROUND OF THE INVENTION

A geographic information system (“GIS”) is a computer run system for capturing, storing, manipulating, analyzing, managing, and presenting geographical (spatial) data concerning a given parcel of land (or fresh water and sea equivalents) or for a space (land or water body) associated with a boundary defined by or including a particular latitude and longitude coordinates. As geographical data is increasingly made available from digitized aerial photography, satellite imagery, and GPS-based surveying tools, GIS has become more important for land management, planning, and use purposes. GIS is employed by a variety of public and private users, including beginning and completing work flow processes for mining, forestry, regulatory, agriculture, land development, etc. GIS data for a parcel of land is provided in computer readable files of various kinds, including, as example only, “shapefile” by Esri (Redlands, Calif., USA).

Shapefiles are available from a variety of web-based (via the Internet or by intranet connections) sources, including local, state, and federal governments (especially regulatory and land management/planning offices) and private companies (e.g., OGInfo.com LLC, Corpus Christi, Tex., USA; Real Estate Portal USA, LLC, Cleveland, Ohio, USA; Digital Globe Longmont, Colo., USA; and others). Most county and state governments provide cadastral (legal survey maps showing boundaries of property ownership) shapefiles that are “official” or “legal” shapefiles for a given land division (e.g., state, county, city, town, village, subdivision, parcel, etc.). State and federal government agencies also provide official shapefiles for various specific regions or subject matter including, for example, zoning, Fish and Wildlife, National Park Service, Federal Wetlands and stream management zone (SMZ) agencies, water quality, weather services, USDA, Army Corp of Engineers, etc. Some governments or agencies outsource GIS shapefiles to contractors (private companies) to provide official shapefiles.

As GIS has become more useful and shapefiles have become more available by web-based sources, users have increasingly started using GIS on handheld (mobile) devices such as a tablet computing device, smart cellular phone, or similar device having relatively sophisticated processing power and supportive communication capabilities. Devices such an iPad™ or an iPhone™ made by Apple Computer or an Android®-based OS mobile computing device and phones are examples of such devices having relatively sophisticated processing power and supportive communication capabilities. Most of these devices utilize standard consumer GPS chipsets that include GPS receivers that can collect data from GPS satellites. A limitation of currently available handheld devices is that they do not provide the computational power to handle large GIS data files (e.g., shapefiles) for viewing or manipulation of data in a shapefile for a work flow process. Another limitation of GIS on currently available handheld devices is that users are more often than not highly trained in GIS. Yet another limitation on GIS on currently available handheld devices is that all relevant shapefiles for a given parcel of land are not equally viewable or useful on all operating system platforms. There exists a need in the field to address these limitations for using GIS on handheld devices.

### SUMMARY OF THE INVENTION

The present invention eliminates the above-identified limitations and disadvantages of the prior art by providing systems and methods for delivering relevant, location-specific GIS information to a handheld (mobile) device for viewing, analyzing, and manipulation. In one aspect, systems and methods are described for requesting all relevant shapefiles or satellite imagery data for a parcel of land from a mobile GIS App and e-commerce web portal. The parcel of land can be designated for request by address, parcel identification, latitude and longitude coordinates, or geolocation data determined by a GPS chip set or other means resident on a handheld mobile device. The system includes a cloud computing environment for processing and storing all requested shapefiles and work flow process shapefiles. The system processing of relevant shapefiles includes rendering the shapefile for portability to multiple smart technology mobile device operating systems. In another aspect, systems and methods are described for creating and delivering concatenated shapefiles from two or more shapefiles to a mobile GIS App and e-commerce web portal. In yet another aspect, systems and methods are described for detecting and alerting a mobile GIS user of an area of contention in a shapefile due to GIS data conflicts between two or more shapefiles. In still a further aspect, systems and methods are described for stitching and delivering 3D satellite imagery to a mobile GIS App and e-commerce web portal.

### BRIEF DESCRIPTION OF THE DRAWINGS

Further advantages of the invention will become apparent by reference to the detailed description of preferred embodiments when considered in conjunction with the drawings which form a portion of the disclosure and wherein:

FIG. 1 is a schematic block diagram of the GIS system of the present invention.

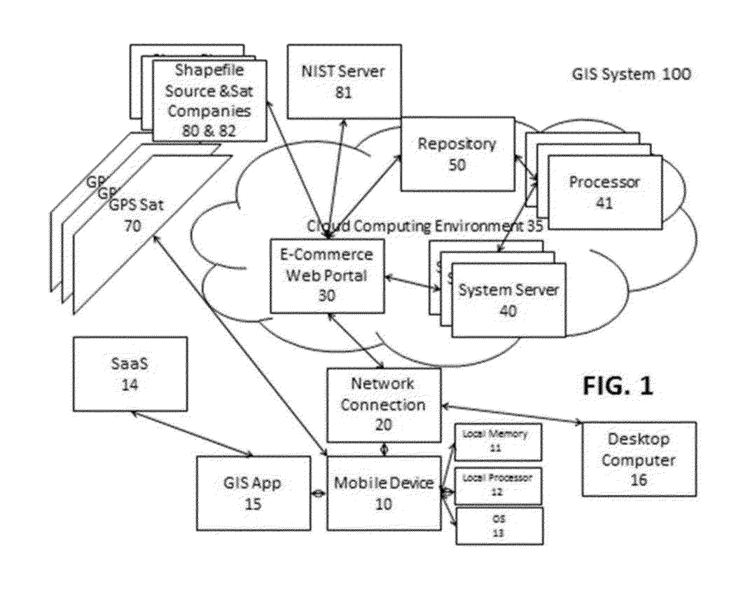

FIG. 2 is a flow diagram showing the steps in requesting a shapefile for a parcel of land using an embodiment of the GIS system.

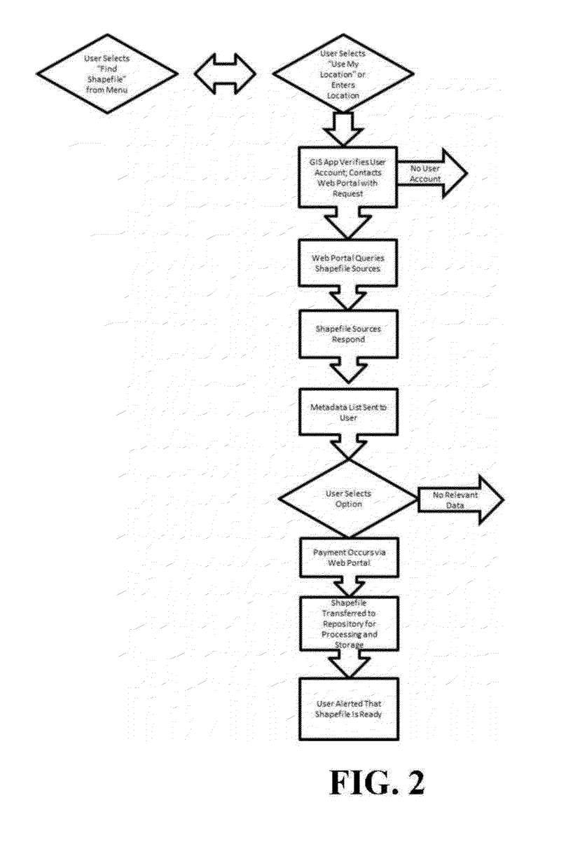

FIG. 3 is an exemplary screenshot of a mobile device running a GIS App of the present invention showing a metadata list for a particular parcel of land located in Anniston, Ala.

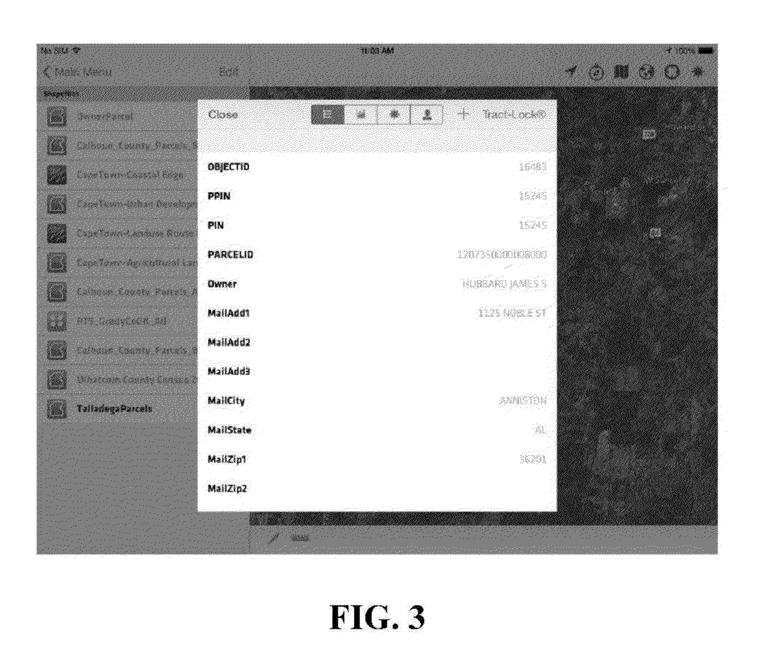

FIG. 4 is an exemplary screenshot of a mobile device running a GIS App of the present invention showing a county government issued “legal” cadastral shapefile with parcel boundaries and highways.

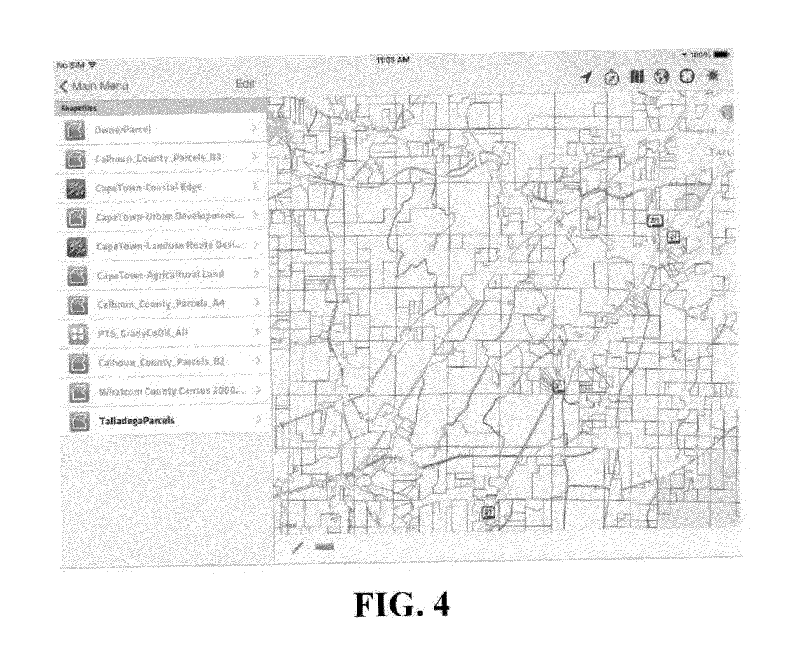

FIG. 5 is an exemplary screenshot of a mobile device running a GIS App of the present invention showing the same cadastral shapefile shown in FIG. 4 with an overlaid satellite imagery data file of the same area.

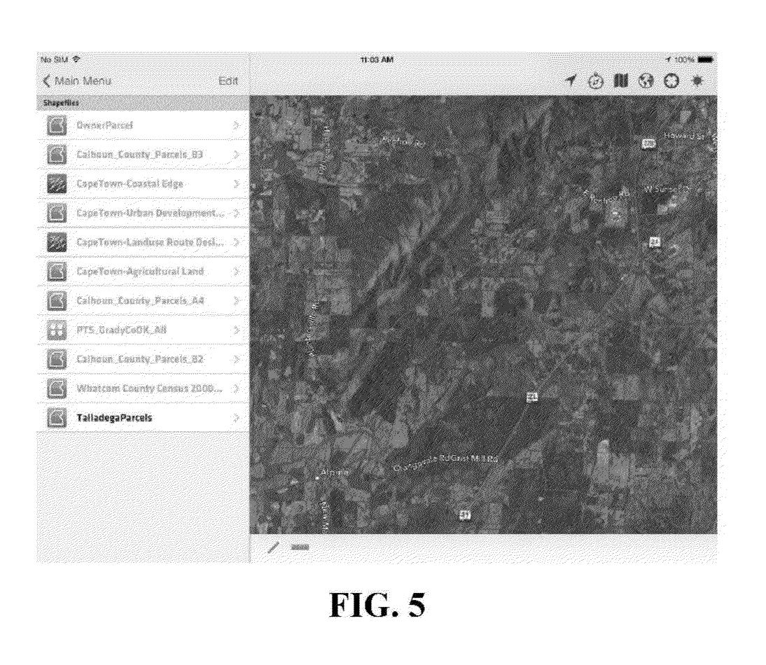

FIG. 6 is an exemplary screenshot of a mobile device running a GIS App of the present invention showing a timestamp with layered GIS information appended to a parcel shapefile.

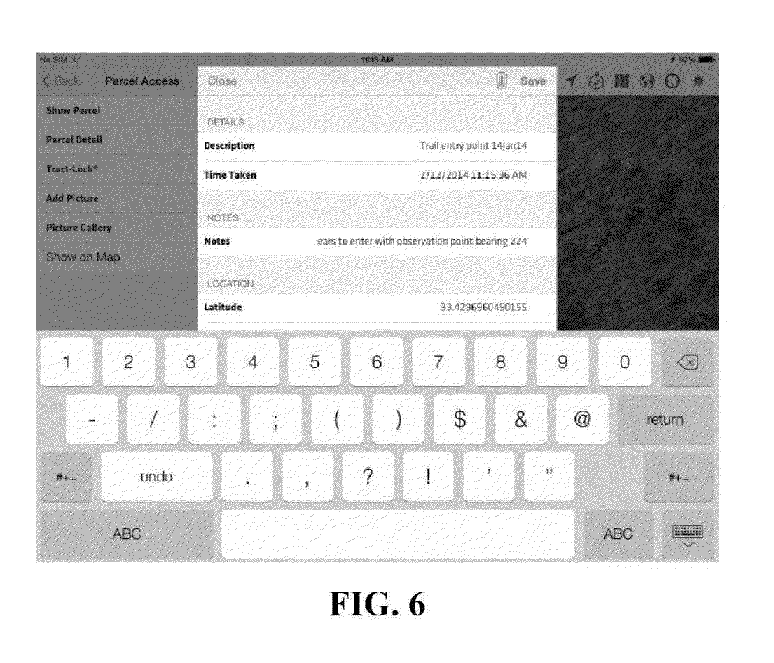

FIG. 7 is an exemplary screenshot of a mobile device running a GIS App of the present invention showing a non-cadastral shapefile map.

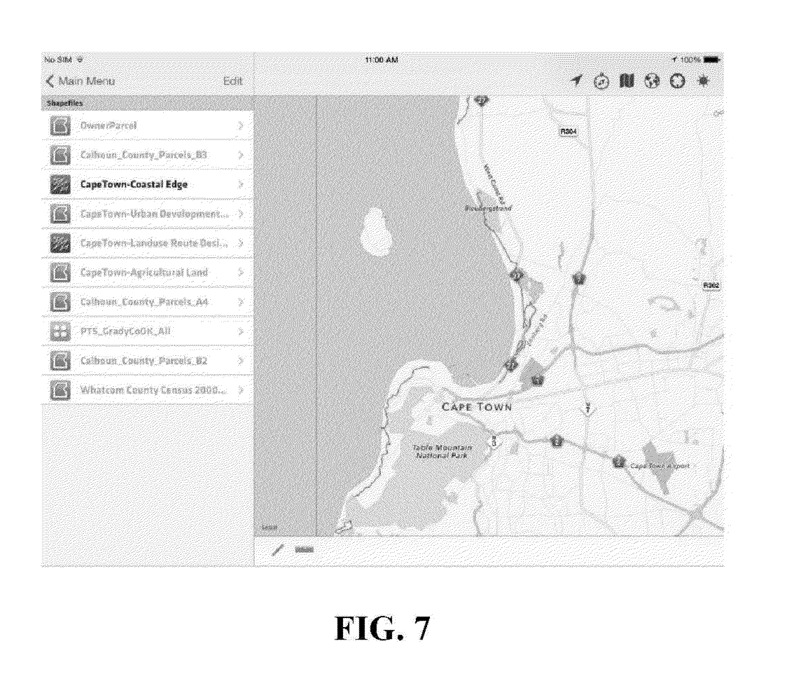

FIG. 8 is an exemplary screenshot of a mobile device running a GIS App of the present invention showing a user repository list in the GIS App.

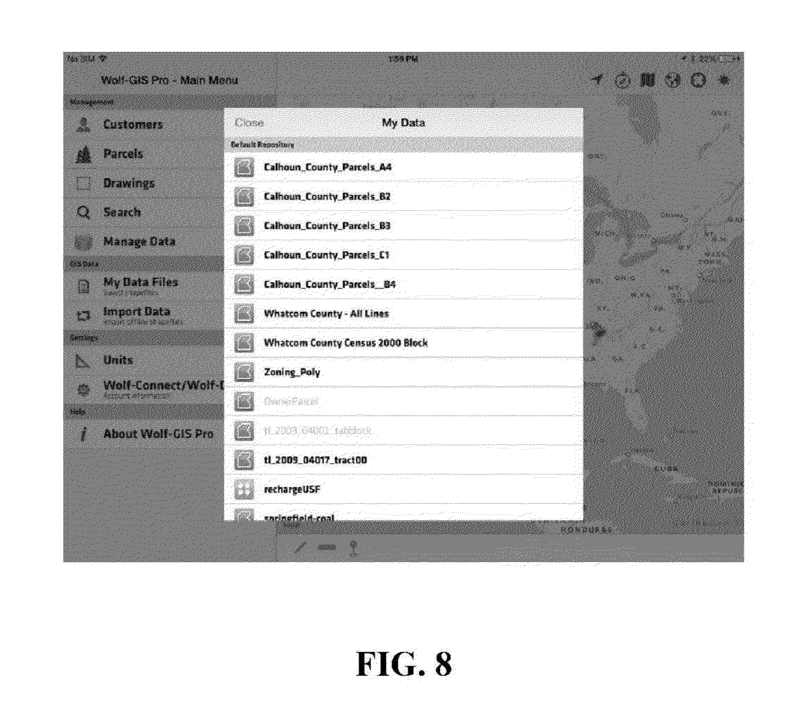

FIG. 9 is an exemplary screenshot of a mobile device running a GIS App of the present invention showing a user entering latitude and longitude coordinates for searching for shapefiles relevant to a particular parcel of land.

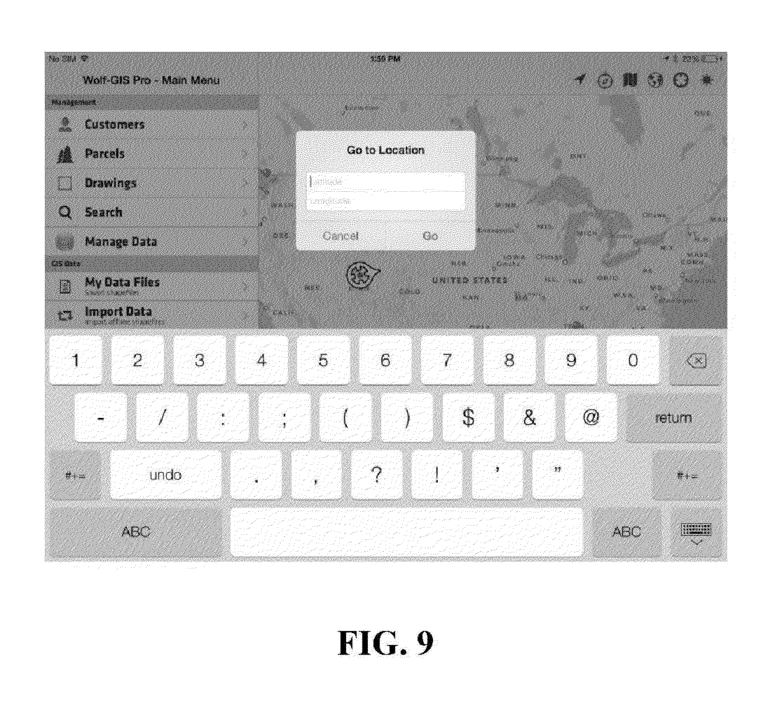

FIG. 10 is an exemplary screenshot of a mobile device running a GIS App of the present invention showing the user login screen of the GIS App.

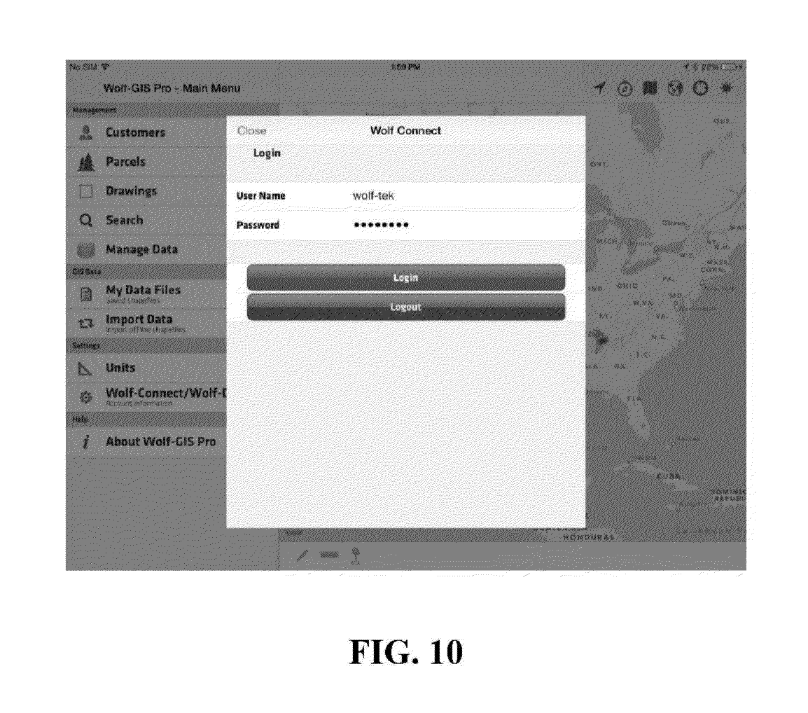

FIG. 11 is an exemplary screenshot of a mobile device running a GIS App of the present invention showing shapefile repository databases available for a user to download shapefile lists to the GIS App.

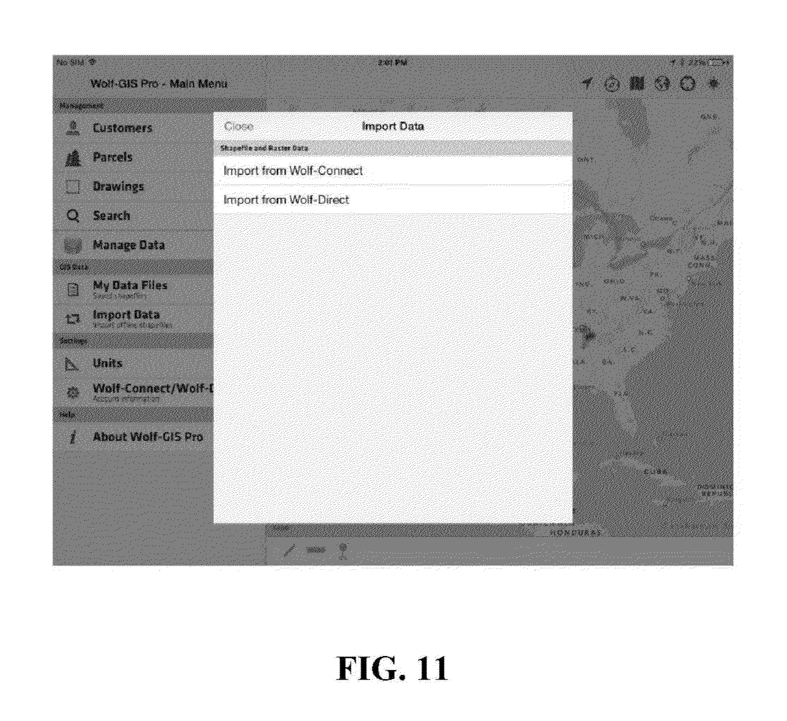

FIG. 12 is an exemplary screenshot of a mobile device running a GIS App of the present invention showing a layered shapefile image, where highlighted shapefiles on the left side of the screen are layered on top of one another in the shapefile view.

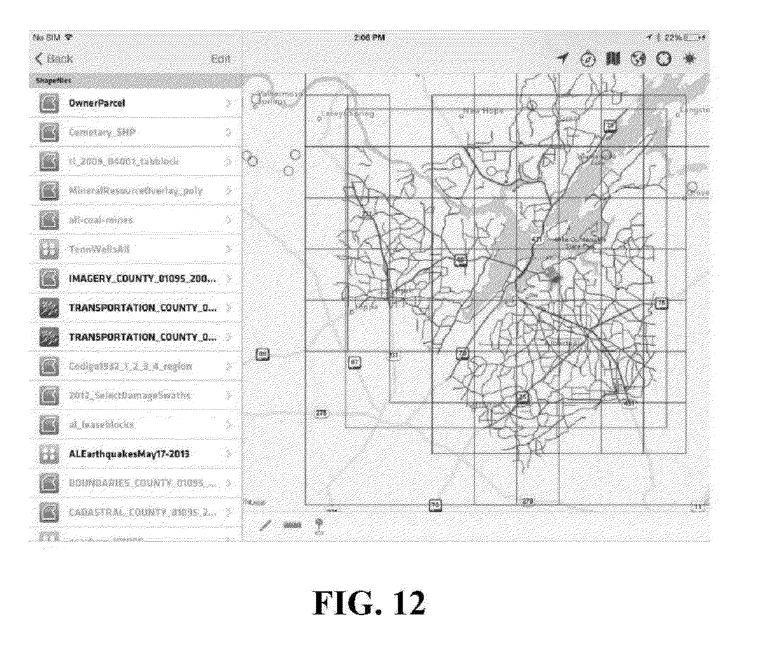

FIG. 13 is an exemplary screenshot of a mobile device running a GIS App of the present invention showing a user searching for shapefiles relevant to a particular parcel of land by land owner name.

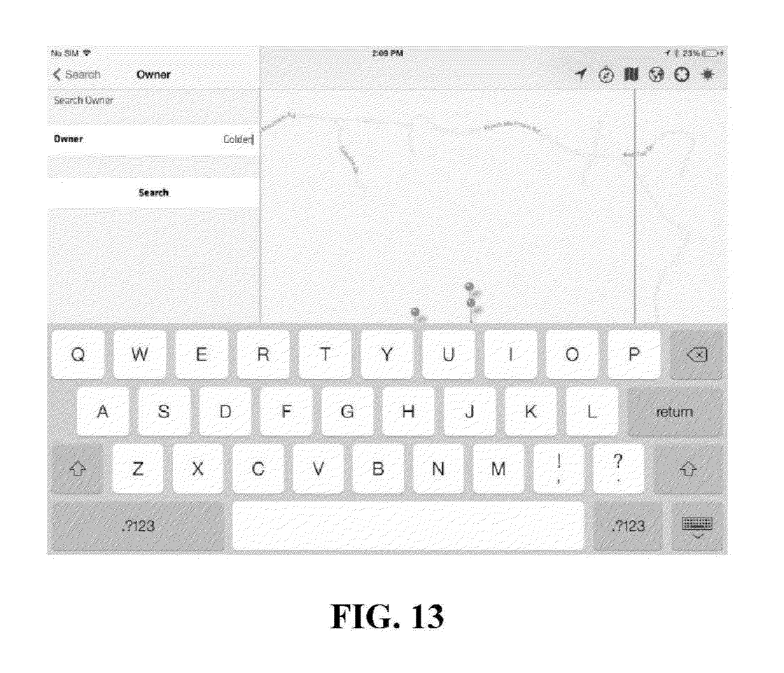

FIG. 14 is an exemplary screenshot of a mobile device running a GIS App of the present invention showing a list of all appended (layered) metadata files for a shapefile.

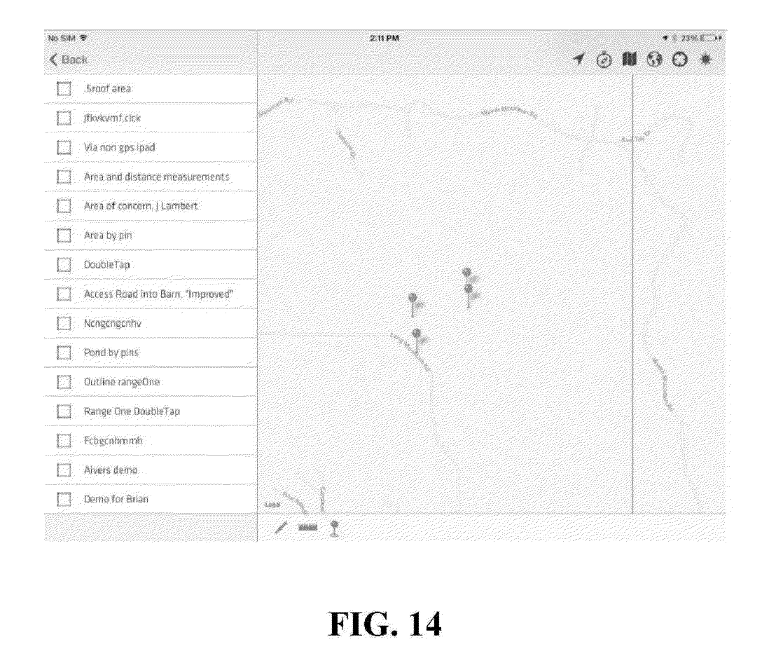

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Handheld mobile devices are being adopted for use as GIS work flow devices (“work flow” is the process of creating, analyzing, and/or manipulating a shapefile, including, but not limited to, adding a geolocation data point to a shapefile, or equivalent GIS data file, for a particular task or job). Mobile device applications (or “Apps”) are being created to put the GIS data that the end user needs to perform his/her task or job into his/her hand. This GIS work flow process has been previously limited to a desktop computing environment (and in some instances, supercomputing environments) due to the amount of computational power required to display, analyze, and manipulate large files, such as shapefiles. As information included in shapefiles expands, the once 2 MB typical shapefile has ballooned to over 20 MB, and it is not uncommon for some shapefile sources to provide shapefiles ranging in size from 80 MB to over one Terabyte. The speed of software applications is directly related to computational horsepower available to the resident software application. Currently available handheld mobile devices simply do not have the computational or memory “horsepower” to support desktop GIS computing models and software applications. GIS data files (e.g., shapefiles) that run seamlessly on a desktop environment are too large or require too much processing power or memory to run on a mobile device properly. The GIS working environment has two components: (1) the GIS Display and Computer Application, and (2) the GIS data file (e.g., a shapefile—the term “shapefile” will be used throughout the instant application in the interest of simplicity and being concise, but a person of ordinary skill in the art would appreciate that many forms of GIS data files exist and can be applied to the systems and methods of the present disclosure). In the case of a handheld mobile device, it is being asked to load a GIS App provide “desktop” performance levels, and load a GIS shapefile. Because both of these were originally designed to only work in a desktop environment, often with supercomputing resources, the limited processing power and memory in a handheld mobile device causes GIS Apps to run slowly.

As desktop environment developed GIS software applications are being rewritten and adapted for mobile devices, these “Apps” are asking for more computational power than is available in the mobile device; therefore, the mobile device GIS user often struggles with poor GIS App performance. Furthermore, when the GIS App is created, it may operate well in the mobile device environment, but as the user adopts the mobile device to more GIS usage, the nature of GIS data files (e.g., large size) and expectations of data that the mobile device can hold or compute becomes unrealistic, manifesting as a degradation in performance and finally the GIS App crashing. Alternatively, the mobile device GIS App may be purposefully limited or diluted in its functionality due to the limitations inherent in the mobile device environment. However, as GIS users become more and more “deployed in the field,” users expect or want the same level of usability in the field as they enjoy on desktop devices. With the current limitations of computational and memory in handheld mobile devices, such expectations are often unrealistic. Thus, one aim of the present disclosure, described in detail below, is to overcome this computing and memory “horsepower” deficiency by effectively turning the GIS user's mobile device into a GIS data (image) display and data entry device, while nearly all GIS computational requirements are performed in the network (“cloud”) environment in a pay-as-you-use basis. Thus, a handheld mobile device can become a true GIS work flow device by offloading the GIS data files to the cloud for processing and saving.

We have solved the problem of limited processing/memory resources for a GIS work flow process on a handheld mobile smart device 10 by providing a GIS system 100 that allows a mobile GIS user to run a mobile GIS App 15 on his/her handheld smart device 10 that merely displays the shapefile image (or in some cases the relevant portion of a larger shapefile image) and allows for data entry concerning that shapefile image directly on the handheld device (e.g., inputting a geolocation data point for a land feature on a parcel of land). The GIS App 15 is stored in and run from the local memory 11 of the smart device 10. Little or no computational power (processor and memory usage) is required by the handheld device 10 in our GIS system 100 because all or nearly all of the computational demands and data storage of shapefiles are handled off of the handheld device 10.

One component of the GIS system 100 is the user's handheld mobile smart device 10. The smart mobile device 10 can run a variety of smart technology operating systems, including iOS™ or Android®. The mobile device 10 must comprise a local processor, a local memory device in electrical communication with the local processor, and means of communication for connecting to the Internet, discussed further below. The mobile device may further comprise a GPS chip set, such as the standard consumer GPS chip sets included in most mobile device 10 available today that include GPS receivers that can collect data from GPS satellites 70 (for a discussion of the GPS chip sets that may be used with the teachings of this application, see U.S. patent application Ser. No. 14/142,316, which is incorporated herein by reference). Another component of the system is a GIS App 15 (for example, Wolf-GIS™ is a GIS App developed for working as a component in the instant systems and methods) developed for running on a variety of handheld mobile device operating systems. The GIS App 15 functions as the mobile GIS user's portal to stored shapefiles, data entry to manipulate shapefiles, and search/obtain new shapefiles. Another component of the GIS system 100 is an e-commerce web portal 30 (for example, www.MyShapefiles.com™ is an e-commerce web portal 30 developed for working in the instant systems and methods) developed for searching and obtaining—including purchasing—relevant GIS data (including shapefiles, rastor files, satellite imagery, etc.).

Another component of the GIS system 100 is an Internet network connection device 20 component of the smart device 10. The network connection device 20 may be any known or developed communication protocol receiver/transmitter or system capable of transmitting and receiving data, including, but not limited to, Bluetooth®, WiFi, Satellite communication, or cellular data protocols such as, but not limited to 3G or 4G LTE (for a discussion of the handheld mobile device communication and network connection means that may be used with the teachings of this application, see U.S. patent application Ser. No. 14/142,316, which is incorporated herein by reference). The e-commerce web portal 30 is linked to the GIS App 15 via the network connection 20 made through the device 10. Yet another component of the GIS system 100 is a system server 40 for storing a user's or user company's GIS data files and other relevant information (e.g., purchase receipts), pre-processing GIS data for use on multiple operating systems, and processing GIS data as a mobile GIS user enters data on his/her device 10 in a work flow process 3. The work flow process 3 includes appending (or layering) metadata into the shapefile by a mobile GIS user, for example, but without limitation, adding a geolocation (Lat/Long) data point to a shapefile noting the physical placement of a surveyor's pin on the corner of a parcel of land. Note how the shapefile data is not altered by the work flow process 3. The work flow data is added to the existing shapefile metadata in a data layer. Thus, the original (and perhaps legal, cadastral shapefile) metadata and timestamp certification remains pristine data. By appending layers of metadata during a work flow process, the mobile GIS user's repository 50 of shapefiles becomes a rich horizontal and vertical hierarchical database of metadata (both certified parcel shapefile GIS data and work flow data each with its own timestamp of occurrence). The GIS system 100 obtains an ultra-accurate timestamp for inclusion in a file's metadata layering by requesting a timestamp from an NIST server 81 or the equivalent for a work flow process 3 event 4. In preferred embodiments, the timestamp is obtained from a dedicated Internet timestamp server (e.g., the “wolfnisttime” server with IP address 207.223.123.18). This timestamp allows a shapefile layered metadata to be tracked and authenticated as genuine, which may be invaluable if a boundary dispute occurs.

The system server 40 comprises a processor or array of processors 41 and a memory device or array of memory devices (including, but not limited to ROM, RAM, Flash, and other forms of memory devices). The system server 40 may comprise a plurality of computer servers 40, which may be remotely located from one another and may perform the same or none of the same functions as other computer servers 40 in the cloud computing environment 35. Thus, the cloud computing environment 35 is a network linked system server 40 (or an array of computer servers 40) in communication with (or capabilities for communication with) the e-commerce web portal 30, which resides on at least one system server 40. The cloud computing environment 35 provides virtually unlimited processing and data storage capacity that a GIS user can access and utilize in a pay-as-you-need or subscription fashion. This unlimited processing and storage capacity allows the mobile GIS user to search, retrieve, and create work flow data in shapefiles in real time on a consumer handheld mobile device 10. The system server 40 tracks system usage for each GIS system user account 31 and stores the usage data in the GIS user's repository 50 where it can be viewed and monitored by the GIS user or account owner. The system server 40 is capable of differentiating a cadastral shapefile (e.g., county parcel map) from a non-cadastral shapefile (Google® maps), and the mobile GIS user will be provided notification on the screen of the GIS App 15 whether the shapefile is a “legal” file or not.

The e-commerce web portal 30 can be accessed directly by a GIS user on the World Wide Web on any computing device, including a desktop computer 16 (e.g., personal computer having a local processor, a local memory in electrical communication with said local processor, and a network connection device) and a handheld mobile device 10, with access to the Internet via a browser. The GIS user can also seamlessly access the e-commerce web portal 30 through the GIS App 15, and although it can be accessed directly as described above, the present disclosure will focus on a mobile GIS user's perspective of accessing the e-commerce web portal 30 via the GIS App 15. The GIS App 15 allows the GIS user to request all or specific relevant GIS data concerning a particular parcel of land from all available shapefile sources 80 on the Internet or through direct networked connections between the e-commerce web portal 30 and private shapefile sources 80. The e-commerce web portal 30 contains search engine bots configured to search the Internet for any shapefile with metadata relevant to the particular parcel of land that the mobile GIS user is interested in. Some bots only search known shapefile sources. Other bots scour the Internet for any return of a shapefile. The GIS user can designate or identify the particular parcel of land he/she is interested in by address, by latitude and longitude coordinates, a unique government assigned parcel identity number, or by the geolocation of the GIS user as detected by the mobile device 10 by its GPS chip set, Bluetooth® capabilities, cellular signal triangulation, or a combination of these, all of which are well-known methods in the art.

The e-commerce web portal 30 then sends queries to all known shapefile sources 80 to request any GIS data relevant to the mobile GIS user's parcel of land of interest. Alternatively, the e-commerce web portal 30 may send queries to all known shapefile sources 80 to request specific GIS data, such as shapefiles related to Federal Wetland Regulations, relevant to the mobile GIS user's parcel of land of interest. The shapefile sources 80 are located by the e-commerce web portal 30 by searching and maintaining a database of active shapefile sources 80 (both public and private), real time search engine searches, direct network communication lines with private and public shapefile sources 80, and combinations of these. For better quality control, only “certified” shapefile sources 80 may be included in the queries. Shapefile sources 80 may be certified by reputation for commitment to accuracy in the field, internal quality control measures, guarantees of quality, etc. In the alternative, a mobile GIS user may request the query be sent to all known shapefile sources 80 without regard to certification by the e-commerce web portal 30. Shapefile sources 80 may include local, county, state, federal, and foreign public governments or governmental agencies, as well as private shapefile corporations, both for- and non-profit businesses. When the mobile GIS user requests shapefiles for the exact geolocation he/she wishes to work on, or is physically standing with a handheld mobile device 10 with GPS chip set (or other geolocation means), the GIS App 15 will take the X,Y coordinates (latitude and longitude) and send them to the mobile GIS user's repository 50 on the system server 40 in the cloud computing environment 35 to be stored as a query site 2.

Some mobile GIS users may request only cadastral “official” or “legal” shapefiles from a government shapefile source 80. These official shapefiles are certified by the government or government agency producing them to be accurate at the time they were produced. Embedded in the shapefile is the build or version number (metadata of the shapefile) along with a timestamp of its creation. The timestamp will be an official timestamp provided by NIST time servers or similar sources 81. By working on official/legal shapefiles, the mobile GIS user will have certainty that the land data (boundaries) are certified to be correct.

The e-commerce web portal 30 then compiles the resulting query data from the shapefile sources 80 into a metadata list 51 that is communicated to the mobile GIS user. The metadata list 51 includes a summary of all data file information 52 necessary for the mobile GIS user to quickly discern the relevancy of each returned shapefile from the query. The data file information 52 may include the identity of the shapefile source 80; the identity of the land covered (geolocation coordinates or other parcel identity); the identity of the type of information overlaid on the shapefile (zoning regulatory, taxation, land management or planning, land/water conservancy, environmental impact(s), parcel boundaries, etc.; whether the shapefile is available for a fee or freely available; and whether the mobile GIS user (or his/her company) has already purchased or otherwise obtained access to the shapefiles in the metadata list 51. Thus, the mobile GIS user can quickly make a decision of whether or not to access any given shapefile. Of course, if no shapefiles are available for the parcel of interest, the metadata list 51 will simply report that no relevant shapefiles are currently available. Each shapefile source 80 may be presented in the metadata list 51 as either having relevant shapefiles or not having relevant shapefiles. If a mobile GIS user knows that a particular shapefile source 80 does or should have a relevant shapefile, knowing whether or not that shapefile source 80 has returned any files may serve as a quality control by the mobile GIS user.

Once all shapefile sources 80 have responded, the built metadata list 51 is then communicated to the mobile GIS user by sending an audio and/or visual alert to the mobile handheld device 10 via the GIS App 15. Alternatively, it may be sent via RSS feed, or NEWS Feed, or e-mail to the mobile GIS user, depending on selected user preferences. The mobile GIS user will then be able to see the metadata list 51 and discern why the data presented is relevant. Preferably, the metadata list 51 is first communicated to the mobile GIS user substantially instantaneously, as an Internet search engine user would expect with an Internet query. Also, the metadata list 51 may be stored in the mobile GIS user's account in the user's repository 50 on the system server 40, which is accessible on the GIS App 15 and the e-commerce web portal 30. The stored metadata list 51 may be updated continuously at regular intervals, e.g., hourly, daily, weekly, etc., to ensure that the available relevant GIS data is kept updated for the mobile GIS user such that each may be retrieved in an “on demand” fashion. At this point, no purchase has occurred. The metadata list 51 is built in the mobile GIS user's repository 50 in the cloud computing environment 35.

Once the mobile GIS user decides whether to access a listed shapefile, the shapefile may have to be “purchased” from the shapefile source 80. Purchasing a shapefile may include conventional purchasing transaction of a data file with all rights or only a subset of rights in that file. Alternatively, a transaction for purchasing a shapefile may require a subscription or other continuous and open-ended access fee for as long as the shapefile(s) in question is accessed. Some shapefiles may be freely available for download, but nonetheless the shapefile source 80 may require providing information about the person or company accessing the shapefile—“non-purchasing” transactions. The mobile GIS user's (or his/her company's) mobile GIS user account 31 stored on the system server 40 all or nearly all necessary information (including preferred username, preferred external password, company name, contact information, billing address, and preferred payment method if different than billing directly through the system) to automatically complete any purchasing or non-purchasing transaction to access any given shapefile from the metadata list 51.

Once a shapefile has been downloaded and stored in the mobile GIS user's repository 50, the e-commerce web portal 30 may query the original shapefile source(s) for updated shapefiles. For example, if the mobile GIS user has requested a cadastral map from a particular county agency GIS portal showing property boundaries in that county where a planned timber harvest is to occur, the e-commerce web portal 30 will regularly (daily, weekly, monthly, etc.) request any updated shapefiles from that county. Alternatively, the e-commerce web portal 30 may be triggered to look for updated shapefiles by input from the mobile GIS user or the mobile GIS user can set a preference to search for an updated shapefile when the shapefile is opened in the GIS App 15. If the county has updated the shapefile, such as changing a boundary line (e.g., a court case involving a boundary dispute has been disposed and recorded) or a property owner (e.g., a parcel has been conveyed and recorded), the e-commerce web portal 30 will retrieve this updated shapefile for the mobile GIS user without input from the user. The original county shapefile and the updated county shapefile include timestamp metadata that distinguish them. The system server 40 preprocesses the updated county shapefile for portability on the mobile GIS user's mobile device 10. If the mobile GIS user has started a work flow process 3 and appended data onto the original county shapefile, the e-commerce web portal 30 directs the system server 40 to append the mobile GIS user's metadata from the work flow process 3 onto the updated county shapefile. The work flow data retains its original timestamp metadata. Thus, the GIS system 100 automatically maintains updated shapefiles of the mobile GIS user's work flow process. Because the processing and storage of the shapefiles are all done in the cloud computing environment 35, the mobile GIS user may not notice the updated shapefile, even if the update occurs while the shapefile is in use in a work flow process 3.

In preferred embodiments, the mobile GIS user need only press the specific link within the metadata list 51 which then sends a “purchase request” to the mobile GIS user's repository 50. The system server 40 picks up the “purchase request” and completes the transaction of the data from the relevant shapefile source 80. As each transaction for requested shapefiles or other GIS data is processed, the shapefiles are stored into the mobile GIS user's repository 50 and made available for opening. As some shapefile vendors 80 process data requests slower than others, as each shapefile is confirmed to be available in the mobile GIS user's repository 50, a notification is then communicated to the mobile GIS user by sending an audio and/or visual alert to the mobile handheld device via the GIS App 15. Alternatively, it may be sent via RSS feed, or NEWS Feed, or e-mail to the mobile GIS user, depending on selected user preferences. A receipt of purchase is also placed in the mobile GIS user's repository 50 and issued to the mobile GIS user via RSS feed, NEWS Feed, and/or e-mail. The receipt may be viewed, downloaded, or printed from the mobile GIS user's repository 50 at any time. If any additional information not stored in the mobile GIS user's account 31 is required to complete a transaction, the mobile GIS user will be prompted through the GIS App 15 to enter the necessary information.

Also, if areas of contention 8 (any land or area where two shapefiles conflict as to the geolocation of internal structural or boundary data) are detected by the cloud computing environment 35 during processing, these are also noted for the mobile GIS user. For example, if two available shapefiles for a given parcel of land bordering a Federal Wetlands area having different geolocations for the Wetlands boundary are returned in the query, the area of contention 8 is highlighted on the shapefile(s) viewed by the mobile GIS user. Areas of contention 8 may occur from a variety of sources, such as data entry errors, course meanderings for a flowing body of water, satellite imagery capture and/or process errors, etc. If known, contact information for appropriate government agency(ies) having the ability to correct or provide certified boundary data are provided in the e-commerce web portal 30 and GIS App 15 for the mobile GIS user's convenience. Areas of contention 8 and methods for detecting and reporting the same are discussed further below.

Each shapefile that the mobile GIS user currently has access to or has otherwise saved on the system server 40, will be visible and available to load through the GIS App 15 in the GIS user's repository 50. The mobile GIS user can then “open” a shapefile in the GIS App 15 to view or to begin/continue a work flow process 3. As previously mentioned, in order to mitigate the resource limitation of handheld mobile devices 10 and to offer “supercomputing” performance to the mobile GIS user in an automated way, the e-commerce web portal 30 takes advantage of the cloud computing environment 35, via the network connection 20 and the system server 40, to pre-process shapefiles for display on practically any handheld mobile device 10 (for more on the portability of shapefiles using the disclosed systems and methods, see below). Pre-processing a shapefile may include breaking them into smaller portions related to the geolocation of the mobile GIS user's handheld mobile device 10 and/or pre-rendering those shapefiles. The cloud computing environment 35 also offers automatic and near real time back up of any work flow processes 3 that the mobile GIS user applies to that portion of the shapefile (e.g., adding a geolocation perimeter within a shapefile for a planned building on a parcel of land). In short, cloud computing environment 35 acts as the GIS supercomputer so that the handheld mobile device 10 is nothing more than a GPS geolocation detector, data display, and data entry portal. All other processing would be handed off to the cloud computing environment 35. This means the handheld mobile device 10 would have near unlimited processing power and near unlimited storage capability, all in an automatic or on demand fashion, such that the end user need not be an expert in GIS application, supercomputing, or databases.

Thus, resource limitations of handheld mobile devices 10 do not affect mobile GIS user's experience. The cloud computing environment 35 offers unlimited pay-as-you-need processing power and storage. The handheld mobile device 10 need not hold (locally store in local device memory 11) all relevant shapefiles, only the one(s) the mobile GIS user needs in the moment of the work flow process 3. This frees up needed resources to the handheld mobile device 10. As a person of skill in the art would appreciate, some shapefiles are immense in data sets reaching greater than one Terabyte of data. The very adoption of shapefiles to geolocate relevant data means that some data sets and file sizes associated to shapefiles have become too large for handheld mobile devices 10 to support. Therefore, the e-commerce web portal 30 may partition the shapefile and provide (send to the handheld mobile device 10) only the data relevant to the actual geolocation of the mobile GIS user.

As the mobile GIS user moves, the geolocation is continuously updated and may be communicated to the system server 40, which may trigger the next block of data from the stored and pre-processed shapefile to be downloaded to the handheld mobile device 10 from the cloud computing environment 35. Vector mathematics well-known in the art may be used to accomplish this task. The portion or area that the mobile GIS user has moved from will thus contain the work flow data 4 entered and this data is automatically saved to the relevant shapefile in the mobile GIS user's repository 50 on the system server 40, as long as the network connection 20 and network access remains. When network access is down or temporarily unavailable, such as when a mobile GIS user migrates to a location where signal strength for the network connection 20 falls below standard operating norms, the entered GIS data is saved locally on device memory 11. The GIS App 15 may then regularly send requests to the mobile device 10 to check for network access and to resend the locally saved GIS data once the network connection is reestablished. Once the data upload and save is accomplished and verified, the non-active portion of the shapefile would be “unloaded” from the mobile device 10, thereby releasing valuable, needed processor and memory and other resources. The mobile GIS user does not have to request saving of data to the repository 50.

Further, through the use of industry standard MIBs, if the mobile GIS user's handheld mobile device 10 is approaching a critical resource over load, the MIB will “fire” and the GIS App 15 will push an autosave of GIS data back to the mobile GIS user's repository 50. Thus, the GIS App 15 practices pre-emptive resource monitoring and takes actions beyond normal autosave intervals when necessary, to save all changes and data entry of all GIS data the mobile GIS user has geolocated in the shapefile he/she has open and is working in. MIB's will monitor the handheld mobile device 10 for actions or indications that could potentially result in a loss of data, such as processor use, memory usage, GPS chip set health and welfare, battery life, etc. One other feature via the GIS App's use of an MIB is that if the MIB measures a loss of cellular signal strength, e.g., a decrease in dB, all data will be saved locally to the internal memory of the handheld mobile device 10. When the MIB recognizes an acceptable communication signal strength, the GIS App 15 will immediately attempt to resend the GIS data back to the mobile GIS user's repository 50. The GIS App 15 may issue a pop-up message on the screen of the handheld mobile device 10 that will only go away once the mobile GIS user acknowledges the alert.

By freeing up precious mobile device computational power and memory, the instant disclosure next aims to further describe the user-friendly GIS App 15 for mobile GIS users in the field to start or complete a GIS work flow process 3 by supplying “real time” access to native and modified shapefiles that can be viewed seamlessly on a variety of operating system platforms, described in detail below. In the past, GIS was a desktop environment tool used by highly skilled and technically trained people to do specific jobs for companies or government offices/agencies with a single subject matter focus (e.g., land management and forecasting in fields such as drilling/mining, forestry, and land development), and the desktop environment often included supercomputing capabilities. The training of the GIS desktop operator needed to be comprehensive, not only in the GIS world, but also in database and computing technologies. Subject matter expertise was provided by the GIS technician's employer. The current trend is to commercialize GIS to make it accessible to a wider audience of potential users. These potentially new GIS users have little or no GIS expertise, let alone computer skills. However, the new GIS user now is often a subject matter expert (forestry, mining, land management, regulatory, land conservation, etc.) who does not have a background in GIS technology, database creation or mining, computing, supercomputing, network/cloud technology, or mobile device technology (“smart device technology”).

The commercialization of GIS technology and widespread use of shapefiles means there is now a compelling business model to sell shapefiles that are relevant and specific to the creators' and potential users' subject matter expertise. Examples of these newly available shapefiles are the shapefiles or other data files created by the Environmental Protection Agency (EPA) of the US Federal Government detailing lands demarcated as Federal Wetlands or other vulnerable lands subject to federal government regulatory oversight. Another example is a shapefile created by a private company showing current zoning ordinances in a particular municipality or county.

In addition, GIS users create work flow and productivity shapefiles that are unique to their needs or tasks. One private forestry company will not conduct its business in the same manner as another private forestry company. Each private forestry company will need the shapefiles relevant to their unique work flow process and parcels of land with timber rights. For example, a private forestry company operating exclusively on mountainous terrain in Montana will probably not often need municipal zoning ordinance shapefiles or Federal Wetlands shapefiles. On the other hand, a different private forestry company operating near a city located in the Mississippi River delta region will probably need municipal zoning ordinance shapefiles as well as Federal Wetlands shapefiles. Both companies will want immediate access to their own shapefiles, whether created in-house or purchased from a third party vendor, showing the parcel of land with timber rights in question. These are just some examples of possible users of commercialized GIS technology and the types of shapefiles needed in individual bases.

Thus, it should be appreciated that each mobile GIS user needs access to whatever shapefiles are relevant to a particular task at any given moment, preferably in real time onto their mobile devices. To use a handheld mobile device as an effective, productive GIS work flow tool, shapefiles from multiple sources may need to be accessible in a real time “on demand” manner, at a cost effective rate, and ready to use in a mobile device that may be running one of many different operating systems. In fact, companies offering shapefiles are literally springing up all around the globe. Each such shapefile vendor 80 (also referred to herein as a “third party vendor”) or public source may or may not have a shapefile product that is relevant to a mobile GIS user at any given moment, and the mobile GIS user does not have time in his/her busy workday to keep track of all the new shapefile vendors, sources, and updated regulatory shapefiles that become available on a daily basis. The mobile GIS user may not even be aware that a third party vendor has relevant shapefiles for his/her job site. Therefore, the mobile GIS user needs a web search tool (or a GIS App 15 with access to the same) that will respond in real time to queries with all relevant shapefiles that are available concerning their job site in an automated or seamless way.

Further, many shapefile vendors 80 have their own version of industry standard shapefile “type,” file format, file fields, etc. (such as Esri, TAR, etc.). What this means to the mobile GIS user is that relevant shapefiles may exist for his/her job site, but his/her mobile GIS App 15 may not process or display correctly. This is a very common problem given the resource limitations of a mobile device, who is developing the GIS App software, and the developer's background in GIS and smart device technology App development for multiple operating systems. This creates a problem for the mobile GIS user as some smart device technology operating systems do not support some shapefile data types or formats. Further, some smart device technology operating systems prefer certain file types for maximum performance, while other operating systems support/prefer for other file types for maximum performance. This means that if a mobile GIS user's company has a mixture of iOS™ and Droid® running mobile devices, portability of a shapefile through a job life-cycle can be extremely problematic. These problems manifest themselves on a mobile GIS App as unable to recognize file types, poor performance, or complete mobile GIS App failure.

To solve the portability of GIS data file problem across multiple operating systems, we have developed the above described system that includes the e-commerce web portal 30. As described above, the e-commerce web portal 30 can be accessed directly by a GIS user on the World Wide Web on any computing device, including a handheld mobile device 10, with access to the Internet via a browser. The mobile GIS user can also seamlessly access the e-commerce web portal 30 through the GIS App 15, and although it can be accessed directly as described above, the present disclosure will focus on a mobile GIS user's perspective of accessing the e-commerce web portal 30 via the GIS App 15. The GIS App 15 allows the GIS user to request all or specific relevant GIS data concerning a particular parcel of land from all available shapefile sources 80 on the Internet or through direct networked connections between the e-commerce web portal 30 and private shapefile companies 80. The GIS user can designate the particular parcel of land he/she is interested in by address, by latitude and longitude coordinates, or by the geolocation of the GIS user as detected by the mobile device 10 by its GPS chip sets, Bluetooth® capabilities, cellular signal triangulation, or a combination of these.

The e-commerce web portal 30 then sends queries to all known shapefile sources 80 to request any GIS data relevant to the mobile GIS user's parcel of land of interest. Alternatively, the e-commerce web portal 30 may send queries to all known shapefile sources 80 to request specific GIS data, such as shapefiles related to Federal Wetland Regulations, relevant to the mobile GIS user's parcel of land of interest. The shapefile sources 80 are located by the e-commerce web portal 30 by searching and maintaining a database of active shapefile sources (both public and private), real time search engine searches, direct network communication lines with private and public shapefile sources 80, and combinations of these. Shapefile sources 80 may include local, county, state, federal, and foreign public governments or governmental agencies, as well as private shapefile corporations, both for- and non-profit businesses. As more shapefiles are created and made available by shapefile vendors 80 and governmental agencies 80 displaying their “subject matter expertise,” a parcel of land might have many different shapefiles relevant to it. Examples might be: county tax shapefiles, zoning shapefiles, Federal Wetlands shapefiles, state game management shapefiles, mining-related shapefiles, USDA shapefiles, shapefiles related to past or present agricultural land usage, shapefiles related to local land reclamation efforts, buried utility shapefiles, and high tension electric lines shapefiles, histogram shapefiles related to weather (including flooding and wind susceptibility), topographic shapefiles indicating public, private, and abandoned roads and right-of-ways, etc. The e-commerce web portal 30 compiles the resulting query data into a metadata list 51 that is communicated to the mobile GIS user. The metadata list 51 includes a summary of all data file information 52 necessary for the mobile GIS user to quickly discern the relevancy of each returned shapefile from the query. The data file information 52 may include the identity of the shapefile source; the identity of the land covered (geolocation coordinates or other parcel identity); the identity of the type of information overlaid on the shapefile (zoning regulatory, taxation, land management or planning, land/water conservancy, environmental impact(s), parcel boundaries, etc.; whether the shapefile is available for a fee or freely available; and whether the mobile GIS user (or his/her company) has already purchased or otherwise obtained access to the shapefiles in the metadata list 51. Thus, the mobile GIS user can quickly make a decision of whether or not to access any given shapefile. Of course, if no shapefiles are available for the parcel of interest, the metadata list 51 will simply report that no relevant shapefiles are currently available.

Each shapefile that the mobile GIS user currently has access to or has otherwise saved on the system server 40, will be visible and available to load through the GIS App 15 in the GIS user's repository 50. The mobile GIS user can then “open” a shapefile in the GIS App 15 to view or to begin/continue a work flow process 3. As previously mentioned, in order to mitigate the resource limitation of handheld mobile devices 10 and to offer “supercomputing” performance to the mobile GIS user in an automated way, the e-commerce web portal 30 takes advantage of the cloud computing environment 35, via the network connection 20 and the system server 40, to pre-process shapefiles for display on practically any handheld mobile device 10. Pre-processing a shapefile may include breaking them into smaller portions related to the geolocation of the mobile GIS user's handheld mobile device 10 and/or pre-rendering those shapefiles. The system server 40 pre-processes purchased and stored shapefiles in the mobile GIS user's repository 50 with the pre-render engine 42 (stored on at least one memory device on a system server 40) such that the shapefiles can be viewed on mobile devices 10 running one of several smart technology operating systems by converting all shapefiles into a common shapefile set of types, tuned to operate at maximum performance on the handheld mobile device 10 the mobile GIS user is using (can be set by user preference). This allows for pre-rendering of all shapefiles without diminishing the datasets of the shapefile for portability between versions of devices 10 and version of operating systems and operating systems.

The system's cloud computing environment 35 also detects and presents areas of contention to mobile GIS users for study and analysis. As GIS becomes more “mainstream”, there is more potential for GIS data conflicts between shapefile data sets, e.g., manual data entry or geolocation errors. These often involve conflicts concerning the exact location of property boundaries, streamside management zone (“SMZ”), etc. Further, areas of contention might be a shapefile that shows a wetland and the mobile GIS user can find no indication of wetland currently, or perhaps there is evidence that the flowing body of water (e.g., stream or river) has made such a drastic change of course (e.g., meander) that the wetland GIS data is or may no longer be relevant.

The GIS system's 100 cloud computing environment 35 (including the e-commerce web portal 30) detects and maps these “areas of contention” 8 (any land or area where two or more shapefiles conflict as to the geolocation of GIS metadata). This can include property boundaries, stream beds, roads, easements, zoning boundaries, conflicting regulatory issues, etc. Thus, an area of contention 8 exists any time two or more shapefiles conflict in the same GIS metadata (the geolocation/geospatial location data of where certain structural/physical features, boundaries, or other features are located), which may cause the mobile GIS user to not know the true geolocation of a parcel feature as it relates to the shapefile map.

Another example of an area of contention 8 would include a shapefile data point that is in contention of a surveyors pin in the ground. In this case the mobile GIS user would walk to the pin, add that pin's geolocation to a shapefile in a work flow process 3, and then ask the GIS App 15 to map and perform analytics using the “Area of Contention” feature within the GIS App 15. The e-commerce web portal 30 through the cloud computing environment 35 would then create a shapefile called “Areas of Contention” 8 showing areas where at least two shapefiles disagree in their GIS metadata. Knowledge of or the ability to calculate an area of contention 8 has many uses. For example, knowing where areas of contention 8 are located on a job site property may allow job planners to prevent work from occurring near these areas until the contention can be resolved. Also, knowing where areas of contention 8 exist may allow a mobile GIS user to map out where the parcel can be utilized.

In addition to detecting and displaying areas of contention 8 in a parcel shapefile, the instant GIS system 100 may also include a feature where the cloud computing environment 35 can provide a GIS user with concatenated shapefiles 7 where boundary GIS metadata from two or more shapefiles are in conflict. Boundary GIS metadata may include the boundary between two parcels, the boundary of a zoning regulation residing within the parcel in question, the boundary of a Federal Wetlands area within or on the periphery of the parcel in question, or other boundaries. The resulting concatenated shapefile 7 allows the GIS user the ability to provide a determined or an averaged boundary to use in the face of the conflict. The concatenated shapefile 7 also allows the GIS user the ability to quickly visualize and know what areas are NOT in contention, and thus may proceed with the planned course of action or development even where a conflict is situated nearby.

The GIS App 15 and e-commerce web portal 30 provide several options for how the concatenated shapefile's 7 average boundary is to be determined. One method of determining a boundary in contention for a concatenated shapefile 7 is the “best fit” method. The GIS system 100 performs the concatenation by a shapefile concatenating engine (stored on at least one memory device on a system server 40). Determination of the “best fit” parcel or sensitive area boundary might utilize one of many different possible algorithms. Depending on many factors, including the number of and variance between the data sources, the algorithm may produce significantly different results (the GIS user may want to know this as well in order to select which algorithm to apply). One method would be to determine the midpoints between the minimum and maximum data points from the data sources and plot those midpoints as the boundary line. Another best fit method would be to find the mean boundary line amongst all the data sources and plot this as the mean boundary line. A person of skill in the art would appreciate that it is not safe to assume that the differences between data sources depict the same outline shapes (identical shapes differing only in area). The boundary lines from one source to another source may not be parallel, and indeed the boundary lines may cross or overlap. Never-the-less, algorithms to determine the midpoint between minimum and maximum data sources or the mean amongst multiple data sources involve basic mathematics only.

The GIS user may also use the GIS App 15 and/or e-commerce web portal 30 to determine the what area of land and what percentage of land (as to the total expected area) is excluded from use as the result of any best fit boundary determination algorithm, as discussed above. Note the premise here of the GIS user's assumption that the largest boundary data source represents the actual maximum area to access. Calculation of the area created by any solution for determining the boundary from available data sources, and comparing it to the area of the largest possible boundary, is basic mathematics. The polygon area method: For a parcel having a polygon-shaped boundary, the area determination for many basic polygons utilize basic, common formulas; base×height, ½×base×height, ½(a+b)×h, and so forth. Given that many parcels may be complex polygons, area determination may be accomplished by starting anywhere in the parcel and defining the largest “simple” polygon, calculating its area (A₁), and then defining another simple polygon (A₂) in the remaining area, and so forth until all of the parcel has been covered by defined simple polygons. The sum is then taken of all defined simple polygons (Aₙ), where “n” equals the number of area calculated total. Resolution is limited only by the precision of the latitude and longitude (“Lat/Long”) data, and by how closely the set of defined simple polygons match the desired complex polygon of the parcel. Curved boundaries offer a simple visual of this resolution concept, where a series of polygons cannot precisely define the total area, but nevertheless provide a useful approximation. The centroid area method: Another approach is to select an approximate centroid (“geometric center”—for the purpose of the GIS App, it does not have to be exact, and would be best offset to accommodate acute concave boundary sections), and simply rotate x degrees for each simple polygon (long, skinny triangle) creation. This is repeated for 360 degrees total, and the sum of all areas is taken to provide the centroid area. Resolution is defined by the degrees of rotation used to create each simple polygon. The area of a complex polygon is thus given by the following, where A equals Area, and where 1, 2, . . . n represent all of the simple polygons used to define the complex polygon area: SUM(A₁+A₂+ . . . Aₙ)=Area of complex polygon.

DETERMINATION OF “BEST FIT” AMONGST MULTIPLE BOUNDARY SOURCES: This problem has several possible solutions. Explanation of some of the possible solutions is supported with a simple model, where each of the various boundary depictions are nested, meaning they, from Lat/Long data or distance from a centroid depiction, fit “inside” of one another. Other cases will be touched upon in a moment. It is also assumed that the largest parcel represented by the multiple sources is likely outside of the actual boundary; therefore, a reasonable determination of a more accurate, closer to actual, “best fit” boundary is desired. If there are two boundary definitions (i.e., an area of contention from two conflicting shapefiles), the only option is to split the difference. If there are three or more conflicting shapefiles, one option is to work only with the min and max of the set, again splitting the difference. Computationally, and again much aided by computing power, there are at least two methods for determining the best fit boundary in this case. One utilizes Lat/Long data, while the other references from a centroid. If there are three or more boundary sources, computing the mean position of the set would be the most representative of the actual boundary. This calculation again would be accomplished by Lat/Long data or the centroid approach. In the centroid example, the distance along a radius from the centroid, to its intersection with each member of the boundary set, would be summed and divided by the number of members, and that distance would be a best fit boundary vertex. Resolution is again controlled by the degrees of rotation for each radius used. As promised, there will certainly be exceptions to the simple model utilized above, where all of the boundary data sources create a nested set. Two examples are: one parcel boundary cutting across the corner of another, and a parcel's boundary cutting inside of and then angling back outside of another parcel's boundary segment. In all cases it appears that non-nested sets results in scenarios where the “larger” appearing boundary does have a section where it has less local area than the “smaller” boundary. This does not affect the calculations or computational methods used above, but it does come into play in the next example. Another exception to the simple model above is when there exist one (or more) parcel vertices that are known in a fashion so as to supersede all other boundary data sets, such as when a court has determined the best fit amongst the data sets and other evidence, and that vertex is marked and or its Lat/Long defined. In those cases, it would be simple to designate a Lat/Long as a “common” vertex amongst all data sets, and reset each data set's local vertex to that position, before doing any best fit calculations. All best fit methods would then arrive at that vertex's defined location.

DETERMINATION OF THE PERCENTAGE OF A PARCEL “LOST” DUE TO LIMITING UTILIZATION TO A “BEST FIT” BOUNDARY: Again it is assumed that any utilization less than that represented by the largest boundary data source is lost utilization. For the simple model, with nested boundary sets, the percentage lost would be represented by:

((Area of largest boundary−Area of best fit boundary)÷Area of largest boundary)×100.

If the exceptions to the simple model noted previously involve the largest, and the best fit boundaries, and it is assumed that the best fit boundary cannot exceed the largest boundary. The Area represented by the incursion of the largest into the best fit would be subtracted from the Area of the largest boundary in the equation above, the result being used in its place. It is the Area of the largest possible boundary that “gives up” to otherwise use the best fit boundary.

Stitching method: For situations where multiple data sources for boundaries of sensitive or protected areas (wetlands, slopes, habitat, etc.), the present GIS system 100 allows for a method of stitching the data sources together to create a rendition depicting (1) the common area amongst all data sources, (2) the area specific to each data source, and (3) the total area of all data sources. The shapefile stitching is performed by a shapefile stitching engine (stored on at least one memory device on a system server 40). Depending on how actual “on-the-ground” observations made by a mobile GIS user might apply and be resolved (e.g., evidence that a river changed course 200 yards twenty years ago), whether setbacks are depicted on the data sources, and whether the setbacks vary by local to federal jurisdiction and local application, the same area mathematics noted above would be used to determine the total area to be excluded from the use for a parcel, and its percentage of the total area (given which algorithm described above is utilized, etc.). The mathematics and equations for determining percentage of area lost due to this data, or comparing the impact of different data sets, are also as detailed above.

The instant system and methods also allow for the query, access, and manipulation of satellite imagery data 7 to create GIS data files with time relevance. A GIS user can use the mobile GIS App 15 or e-commerce web portal 30 to query one or more satellite imagery companies 82 (e.g., Digital Globe, Longmont, Colo., USA]) for images 83 of a parcel of land of interest (as described above for how to search for shapefile data using the mobile GIS App 15 and e-commerce web portal 30). The request made to the satellite data company may include:
(1) Does the Satellite Imagery Company 82 have any images of the parcel having a certain Lat/Long coordinates?
(2) Does the Satellite Imagery Company 82 possess or maintain archived satellite imagery 83 (preferably low cost archived imaging); if so, how old is the image 83?
(3) Does the Satellite Imagery Company 82 have satellite imagery 83 taken within the last week?
(4) Does the Satellite Imagery Company 82 have “histogram data,” for the certain Lat/Long coordinates requested? That is, does the Satellite Imagery Company 82 have satellite imagery 83 taken over time, such that the GIS user could “layer” the satellite images 83 to see changes to the parcel over time?
(5) Does the Satellite Imagery Company 82 have stereoscopic (three-dimensional imagery 84) data available?

The responses to these queries are built into the metadata list 51 returned to the GIS user's repository and device 10. Once more than three satellite images 83 or shapefiles with satellite view data are available in the GIS user's repository 50 for a given parcel of land (or body of water), the e-commerce web portal 30 will offer the GIS user the option of “stitching” those data sets together to create one “3D” virtual reality view 85 of the parcel of land. Further, if the GIS user has more than three satellite images of the parcel of land, the GIS user can select which three of the data sets he/she might want to use in the “stitching” to create the 3D virtual reality image 85. The 3D virtual reality image 85 can optionally be viewed through the GIS App using Google® Glass®, or any HUD technology to include Oculus VR®.

This feature is important when watching changes over a particular period of time. This optional 3D stitching also may be done with imagery that is “high resolution,” such that the GIS user may be able to calculate parcel features such as tree height and tree density (could be used by a forestry GIS user for determining when and where to harvest trees), hot spots in crops as they grow (could be used by a farmer GIS user for determining success or failure of a pesticide intervention), areas of erosion or susceptibility of erosion zones (could be used by a land management firm GIS user for determining placement of retention walls, water drainage infrastructure, or vegetation), grades of slopes and roads (grading information may allow a GIS user the ability determine which equipment would be necessary under OSHA regulations), or comparing areas of SMZs to area of harvest and potential yields (could be used by a forestry GIS user for a parcel containing or adjacent to a regulated area). Areas of contention where there is dispute in property lines can be compared over time for land use and behavior of the parties of conflicting interests. In short, the GIS user may utilize stitching 3D satellite imagery and regulatory images to plan jobs, mitigate regulatory risk, extract maximum value from a parcel of land, etc.

In addition to the above described features, the e-commerce web portal 30 is also configured to be capable of monitoring a mobile GIS user's use of the micro or macro shapefile data in their repository 50 to be able to find trends, and offer consumer technology related to those trends. A further “value added” feature that can be purchased from the e-commerce web portal 30 for use directly on a computer or on a handheld mobile device 10 via the GIS App 15 is the ability to track water usage rights and water usage over time (histograms), including surface and below-ground water, associated with a particular parcel of land and by industry using that water (e.g., mining agriculture, etc.). The e-commerce web portal 30 also provides a mobile GIS user with the optional feature of tracking land usage for a certain parcel of land to include mining (type of mineral produced and amounts), forestry (types of trees and volumes), agriculture (types of crops and yields).

The GIS App 15 and its associated cloud computing environment 35 may be updated or added onto, to support heavy payload GIS computing as use case evolves, and shapefiles with or without added work flow data become more data dense. For example, a new feature to provide a mobile GIS user with a new type of metadata to add to a shapefile during a work flow process may be added. Also, additional system servers 40 may be added in the processor pool to make more processing power available as data increases and more processing power is required to handle cloud computing environment 35 workload. Thus, additional processors can be added “on demand,” based on overall need, without the end user incurring large costs. The addition of more compute services, and any other peripheral service, like revisions of the GIS App 15 or the e-commerce web portal 30, such as added usability to implement improved certified time for hierarchical database certification, human behavioral science algorithms, GIS shapefile stereoscopic layering and opacity control, GIS data file modeling, predictive analytics, tasking “Bots” to acquire more data sets from the Internet by data mining techniques, trend and behavior detection based on unknown need (database Artificial Intelligence, such as detecting consistent boundary line infractions by the user), 2D to 3D stitching to provide non-Euclidian geometry to shapefiles, the ability to layer datasets in an easy to view stereoscopic methodology are all anticipated to be used in the disclosed systems and methods, and therefore within the scope of the present disclosure. Each of these features relies on the cloud computing environment 35 access to virtually unlimited processor and storage capacity and offer the mobile GIS user a powerful handheld tool with infinite possibilities of work flow applications.

The cloud computing environment 35 is built to not only support cadastral shapefiles, that is searching for and retrieving shapefiles with certified cadastral pedigrees, but also augmented shapefile data (e.g., shapefiles that show relevant data as it pertains to the job being done, and the histology of how the “specific” industry works and also that specific mobile GIS user performs his/her job through trend data). Examples might be weather histology (e.g., placement, paths, and chance of occurrence for tornadoes), geology histology (e.g., soil data, soil porosity, fault lines, earthquakes), “crowd source” datasets mined from social media, water sample quality data sets, other shapefiles created and offered from the same industry, etc. Another example is when a mobile GIS user enters a parcel of land on which a regulation has recently changed, such as timber harvesting regulations in a state forest, the mobile GIS user is alerted to these new regulations in real time without asking or knowing that they existed. The cloud computing environment's 35 AI with hierarchical database learns as the database is used by a particular industry or an individual's past specific work flow processes by applying the latest human behavioral datasets. Thus, the GIS App 15 and e-commerce web portal 30 may help the non-expert GIS user in a variety of ways to do his/her job more efficiently with little or no training. For example, the GIS system 100 may point out repeated or consistent parcel boundary incursions by a mobile GIS user or timber harvesting equipment linked to the e-commerce web portal 30. The GIS system 100, as applied to a shapefile, allows the mobile GIS user to understand his environment better with enhanced and learning situational awareness. In other words, the GIS system 100 infrastructure is capable of tracking what the mobile GIS user has done, what the mobile GIS user is doing, and help predict what the mobile GIS user should be doing, all without situational overload.

### Example

A mobile GIS user logs into this GIS App 15 on his/her handheld mobile device 10 at a login screen. Upon entry to the GIS App 15, the mobile GIS user can see a button in the header of the GIS App 15 home screen called “SHAPEFILES FOR THIS GEOLOCATION?” If mobile GIS user presses this button, the GIS App 15, collects the geolocation from the GPS chip set of his/her handheld mobile device 10. The GIS App 15 collects data from the GPS chip set to achieve approximately 50 GPS location readings per minute. The accuracy of the GPS geolocation of the handheld mobile device 10 of the mobile GIS user can be increased by practicing the systems and methods taught in U.S. patent application Ser. Nos. 14/142,316 and 13/728,919, both of which are incorporated by reference in their entirety. The determined GPS geolocation is sent by the GIS App 15 to the e-commerce web portal 30 located on a system server 40, where it is stored in the mobile GPS user's repository 50 as a searched location along with the date and the time of the Lat/Long capture.

The cloud computing environment 35 (the system server 40 and e-commerce web portal 30) then sends the Lat/Long data to all known, available shapefile vendors and at least one satellite imagery company 82 (e.g., Digital Globe) to request all relevant shapefiles and 2D/3D real time satellite imagery 83 data, respectively. Shapefile vendors 80 query their databases, and return any relevant data to the cloud computing environment 35. Relevant files may be augmented to search for “Fuzzy Logic” relationships (i.e., data sets that include any other land parcels owned by the parcel in the subject request, all other parcels in the area that are known to have the same species of trees as the parcel in the subject request, all other parcels for sale in the area that have “like” acreage as the parcel in the subject request, or other relation to the parcel in the subject request).

The returned results are collected by the e-commerce web portal 30 and stored on the system server 40 in the mobile GIS user's database repository 50. The e-commerce web portal 30 then alerts the mobile GIS user, once all shapefile 80 and satellite imagery providers 82 have responded, by sending an e-mail or NEWS Feed, RSS feed to the mobile GIS user with datasets that the mobile GIS user can purchase or otherwise download. The mobile GIS user then chooses data they wish to purchase, using well-known e-commerce protocols and methods. By monitoring the actions and search history of the mobile GIS user, the e-commerce web portal 30 may detect trends and generate emails or other electronic communications directing advertisements for technology that is, for example, related to the mobile GIS user's work flow processes 3 or types of parcels being searched.

Upon acknowledgement from the mobile GIS user, the GIS App 15 purchases the selected shapefile, stores the purchased shapefile in the mobile GIS user's repository 50, pre-processes and pre-renders the shapefile for viewing and manipulation on the mobile GIS user's mobile device 10. Simultaneously, the cloud computing environment 35 would also query appropriate regulatory agencies for any regulatory issues related to the parcel that is the subject of the request. If such information is returned, the e-commerce web portal 30 then sends an RSS feed warning indication into the GIS App 15 that will appear on the screen of the handheld mobile device 10. The e-commerce web portal 30 then generates an e-mail that is sent to the mobile GIS user that data sets are now available in their repository 50, along with a receipt of purchase (also stored in the repository 50).

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A GIS system for delivering location-specific GIS information to a smart mobile device comprising: a smart mobile device having a local processor, a local memory in electrical communication with said local processor, and a network connection device; a mobile GIS application stored on said local memory; a cloud computing environment having an e-commerce web portal, a plurality of system servers, and a user repository; wherein each of said plurality of system servers is in electrical connection with each other via a network link; wherein said plurality of system servers has a plurality of processors; and wherein said e-commerce web portal and said user repository stored in at least one memory device on at least one of said plurality of system servers.

2. The GIS system of claim 1, further comprising a software shapefile rendering engine stored in at least one memory device on at least one of said plurality of system servers.

3. The GIS system of claim 1, further comprising a software shapefile stitching engine stored in at least one memory device on at least one of said plurality of system servers.

4. The GIS system of claim 1, further comprising a software shapefile concatenating engine stored in at least one memory device on at least one of said plurality of system servers.

5. The GIS system of claim 1, wherein said cloud computing environment has a link to a dedicated Internet timestamp server.

6. The GIS system of claim 1, wherein said cloud computing environment is capable of querying multiple shapefile sources for shapefiles relevant to a particular parcel of land in response to a request from a smart mobile device.

7. The GIS system of claim 1, wherein said smart mobile device further has a GPS receiver in electrical communication with said local processor.

8. The GIS system of claim 1, further comprising a desktop computer having a local processor, a local memory in electrical communication with said local processor, and a network connection device.

9. A method for delivering location-specific GIS information to a smart mobile device comprising the steps of:
a. providing a mobile GIS application;
b. receiving a request for GIS information relevant to a particular parcel of land from a user of said mobile GIS application;
c. querying a plurality of shapefile sources for said GIS information relevant to a particular parcel of land;
d. receiving a response from said plurality of shapefile sources;
e. building a metadata list for each GIS information relevant to a particular parcel of land returned from said plurality of shapefile sources;
f. storing said metadata list in a user repository; and
g. sending said metadata list to said mobile GIS application of said user.

10. The method of claim 9, wherein the step of receiving a request for GIS information relevant to a particular parcel of land from said mobile GIS application includes the particular parcel of land being identified by latitude and longitude coordinates.

11. The method of claim 9, wherein the step of receiving a request for GIS information relevant to a particular parcel of land from said mobile GIS application includes the particular parcel of land being identified by geolocation data provided by a said mobile GIS application.

12. The method of claim 9, wherein the step of receiving a request for GIS information relevant to a particular parcel of land from said mobile GIS application includes the particular parcel of land being identified by a government assigned parcel identity number.

13. The method of claim 9, further comprising the step of receiving from said user a selection of a relevant shapefile from said metadata list to retrieve from a particular shapefile source.

14. The method of claim 13, further comprising the steps of receiving said relevant shapefile from said particular shapefile source and storing said relevant shapefile on a system server.

15. The method of claim 14, further comprising the steps of preprocessing said relevant shapefile by a system server processor for portability of said relevant shapefile across a plurality of smart mobile device operating systems and storing said preprocessed relevant shapefile in said user repository.

16. The method of claim 15, further comprising the step of alerting said user that said preprocessed relevant shapefile is in said user repository.

17. A method for processing and storing GIS information in a cloud computing environment comprising the steps of:
a. providing a mobile GIS application;
b. receiving a request from a user of said mobile GIS application to view a shapefile for a particular parcel of land, wherein said shapefile is stored in a user repository in said cloud computing environment;
c. sending said shapefile to the mobile GIS application of said user;
d. receiving a new GIS information data entry entered by said user on said shapefile while using said mobile GIS application;
e. processing said new GIS information data entry as a layer of metadata on said shapefile by a processor in said cloud computing environment; and
f. storing said processed new GIS data entry in said user repository.

18. The method of claim 17, further comprising the steps of receiving a timestamp corresponding to the date and time when said user entered said new GIS information data and saving said timestamp data as layer of metadata on said shapefile.

19. The method of claim 18, wherein said timestamp is received from a dedicated Internet timestamp server.

20. The method of claim 17, wherein said shapefile is a concatenated shapefile and said step of sending said shapefile to the mobile GIS application of said user further comprises processing at least two shapefiles stored in said user repository to form said concatenated shapefile by a processor in said cloud computing environment.
